(19) United States
(12) Patent Application Publication
(10) Pub. No.: US 2024/0170639 A1
(43) Pub. Date: May 23, 2024

(54) LITHIUM WELDMENTS

(71) Applicant: Li-Metal Corp., Markham (CA)

(72) Inventor: Jonathan T. Goodman, Evanston, IL (US)

(21) Appl. No.: 18/057,873

(22) Filed: Nov. 22, 2022

(51) Int. Cl. H01M 4/04; B23K 20/00; H01M 4/38; H01M 4/66

(52) U.S. Cl. CPC H01M 4/0471; B23K 20/002; H01M 4/0435; H01M 4/382; H01M 4/661; H01M 2004/027

(57) ABSTRACT

Lithium anodes that include lithium metal sheets or foils welded to current collectors are described with processes for their formation. One example is a lithium metal anode for use in a battery that includes a current collector carrying proximal lithium metal layers that carry distal lithium metal layers. The proximal lithium metal layers having thicknesses of about 100 nm to about 25 μm and having greater than about 99.5 wt. % lithium, the distal lithium metal layers having thicknesses of about 10 μm to about 200 μm and having greater than about 90 wt. % lithium. Notably, the proximal and distal lithium differ in their average grain sizes with the distal average grain size but at least 1.5 times the size of the proximal average grain size.

### FIELD OF THE INVENTION

This disclosure is directed toward lithium metal anodes and processes for their preparation.

### BACKGROUND

Secondary (rechargeable) lithium ion batteries are used in many applications including automotive, mobile electronic devices, and small or large electrical energy storage systems. Next generation lithium ion batteries vary the common anode, electrolyte, cathode composition and require higher specific energy and higher energy density. However, commercialization has been hindered by performance limitations and practical manufacturing challenges.

Lithium metal anodes can provide higher specific energy and energy density but present metallurgical and handling challenges. Lithium foils, e.g., 20-150 mm thick rolled lithium metal, present mechanical and electronic challenges due to their fragility and relatively poor conductivity. Attempts have been made to press thick rolled lithium metal onto standard copper current collectors, but these resulting products suffer from poor adhesion of the lithium to the copper and poor interfacial conductivity. Accordingly, new products and processes are needed to advance lithium metal anodes for the development of higher energy batteries.

### SUMMARY

A first embodiment is a lithium metal anode for use in a battery that includes a current collector having a first face and a second face, each face, individually, carrying a proximal lithium metal layer that carries a distal lithium metal layer; the proximal lithium metal layer having a proximal thickness of about 100 nm to about 25 μm, about 250 nm to about 20 μm, about 250 nm to about 15 μm, about 250 nm to about 10 μm, about 250 nm to about 5 μm, or about 500 nm to about 5 μm, having an proximal average grain size of about 50 nm to about 5 μm, about 50 nm to about 2.5 μm, or about 50 nm to about 1 μm; and having a proximal composition that includes greater than about 98 wt. %, 99 wt. %, 99.5 wt. %, or 99.9 wt. % lithium, the distal lithium metal layer having a distal thickness of about 10 μm to about 200 μm, about 25 μm to about 175 μm, about 50 μm to about 150 μm, about 50 μm to about 125 μm, about 50 μm to about 100 μm; having an distal average grain size of about 0.1 μm to about 20 μm, about 0.25 μm to about 20 μm, about 0.5 μm to about 20 μm, about 0.75 μm to about 20 μm, about 1 μm to about 20 μm, about 2 μm to about 20 μm, or about 2 μm to about 15 μm, where the distal average grain size is at least 1.5, 2, 2.5, 3, 3.5, 4, 4.5, 5 times the size of the proximal average grain size; having a distal composition that includes greater than about 90 wt. %, 95 wt. %, or 98 wt. % lithium; and having a distal lithium surface that is parallel to the current collector face, where a center-to-edge thickness variation between the distal lithium surface and a current collector face is less than 5 μm, 4 μm, 3 μm, 2 μm, or 1 μm.

A second embodiment is a lithium foil that includes a core metal foil having a width of about 10 cm to about 100 cm, or about 20 cm to about 750 cm, or about 20 cm to about 600 cm, and a length of greater than about 10 m, 20 m, 25 m, 50 m, 75 m, or 100 m, having a thickness between a first planar face and a second planar face of about 4 μm to about 15 μm, about 5 μm to about 12 μm, or about 6 μm to about 10 μm; the first planar face carrying a first proximal lithium metal layer that carries a first distal lithium metal layer; the second planar face carrying a second proximal lithium metal layer that carries a second distal lithium metal layer; each proximal lithium metal layer, individually, having a proximal thickness of about 100 nm to about 25 μm, about 250 nm to about 20 μm, about 250 nm to about 15 μm, about 250 nm to about 10 μm, about 250 nm to about 5 μm, or about 500 nm to about 5 μm, having an proximal average grain size of about 50 nm to about 5 μm, about 50 nm to about 2.5 μm, or about 50 nm to about 1 μm; and having a proximal composition that includes greater than about 98 wt. %, 99 wt. %, 99.5 wt. %, or 99.9 wt. % lithium, each distal lithium metal layer, individually, having a distal thickness of about 10 μm to about 200 μm, about 25 μm to about 175 μm, about 50 μm to about 150 μm, about 50 μm to about 125 μm, about 50 μm to about 100 μm; having an distal average grain size of about 0.1 μm to about 20 μm, about 0.25 μm to about 20 μm, about 0.5 μm to about 20 μm, about 0.75 μm to about 20 μm, about 1 μm to about 20 μm, about 2 μm to about 20 μm, or about 2 μm to about 15 μm, where the distal average grain size is at least 1.5, 2, 2.5, 3, 3.5, 4, 4.5, 5 times the size of the proximal average grain size; having a distal composition that includes greater than about 90 wt. %, 95 wt. %, or 98 wt. % lithium; and having a distal lithium surface that is parallel to the first or second planar face, respectively, a width-thickness variation between the first distal lithium surface and the second distal lithium surface less than 5 μm, 4 μm, 3 μm, 2 μm, or 1 μm.

A third embodiment is a double sided lithium weldment having a thickness of about 50 μm to 500 μm, about 50 μm to about 300 μm, about 50 μm to about 250 μm, about 50 μm to about 200 μm, about 50 μm to about 175 μm, or about 50 μm to about 150 μm and including a current collector metallurgically affixed on a first face to a first lithium layer and on a second face to a second lithium layer; a first weld interface between the first lithium layer and a first lithium foil; a second weld interface between the second lithium layer and a second lithium foil; the weld interfaces, individually, having a thickness of less than 250 nm, 200 nm, 150 nm, 100 nm, 75 nm, or 50 nm; and the weld interface further including a plurality of particulates that include lithium oxide, a lithium nitride, lithium hydroxide, or an admixture thereof.

A fourth embodiment is a process that includes welding a lithium foil to a lithium anode that includes a current collector carrying a metallurgically adhered lithium layer thereby forming a lithium weldment.

A fifth embodiment is a process of forming a double-sided lithium weldment, that includes providing a first lithium foil and a second lithium foil; providing a double-sided lithium anode that has a first lithium layer metallurgically affixed to a first surface of a current collector and a second lithium layer metallurgically affixed to a second surface of the current collector; positioning the double-sided lithium anode between the first lithium foil and the second lithium foil such that the first lithium foil is adjacent to the first lithium layer and the second lithium foil is adjacent to the second lithium layer; and then contemporaneously welding the first lithium foil to the first lithium layer and the second lithium foil to the second lithium layer thereby forming the double-sided lithium weldment.

### BRIEF DESCRIPTION OF THE FIGURES

For a more complete understanding of the disclosure, reference should be made to the following detailed description and accompanying drawing figures wherein:

FIG. 1 is a representation of a cross-section of a herein described double-sided lithium weldment depicting differences in lithium grain structure between layers; and

FIG. 2 is a representation of one embodiment of the lithium weldments described herein;

FIG. 3 is another representation of an embodiment of the lithium weldments described here; and

FIG. 4 is a depiction of a process preparing the herein described double-sided lithium weldment from a double-sided lithium anode and two lithium foils.

While specific embodiments are illustrated in the figures, with the understanding that the disclosure is intended to be illustrative, these embodiments are not intended to limit the invention described and illustrated herein.

### DETAILED DESCRIPTION

Objects, features, and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

Herein, the use of the word “a” or “an” when used in conjunction with the term “comprising” in the claims and/or the specification may mean “one,” but it is also consistent with the meaning of “one or more,” “at least one,” and “one or more than one.” The term “about” means, in general, the stated value plus or minus 5%. The use of the term “or” in the claims is used to mean “and/or” unless explicitly indicated to refer to alternatives only or the alternative are mutually exclusive, although the disclosure supports a definition that refers to only alternatives and “and/or.”

Notably, the disclosed products and processes deal with systems that are generally symmetric about a core or about a current collector. Accordingly, the drawings presented with this disclosure do not distinguish numerically a first side and a second side or a first layer and a second layer as the first and second of any feature is understood to be the corresponding feature on the “other” side of the product. Therefore and throughout the disclosure, the first of a feature and the second of a feature are represented with the same numerical label.

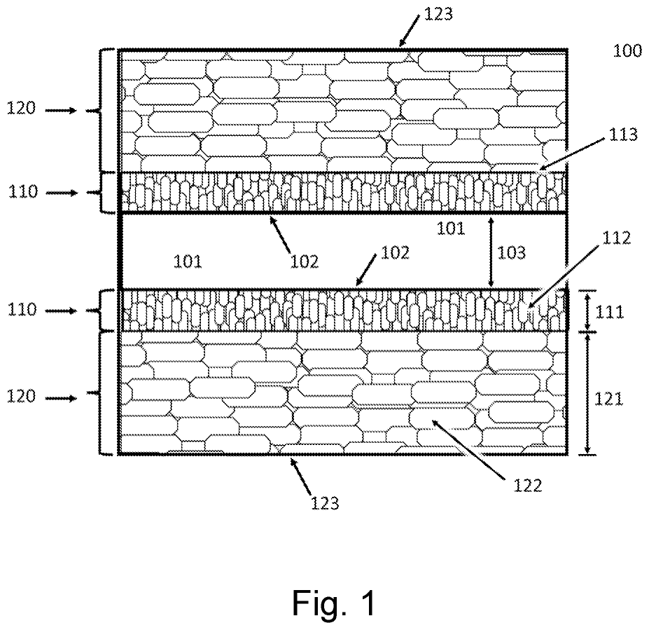

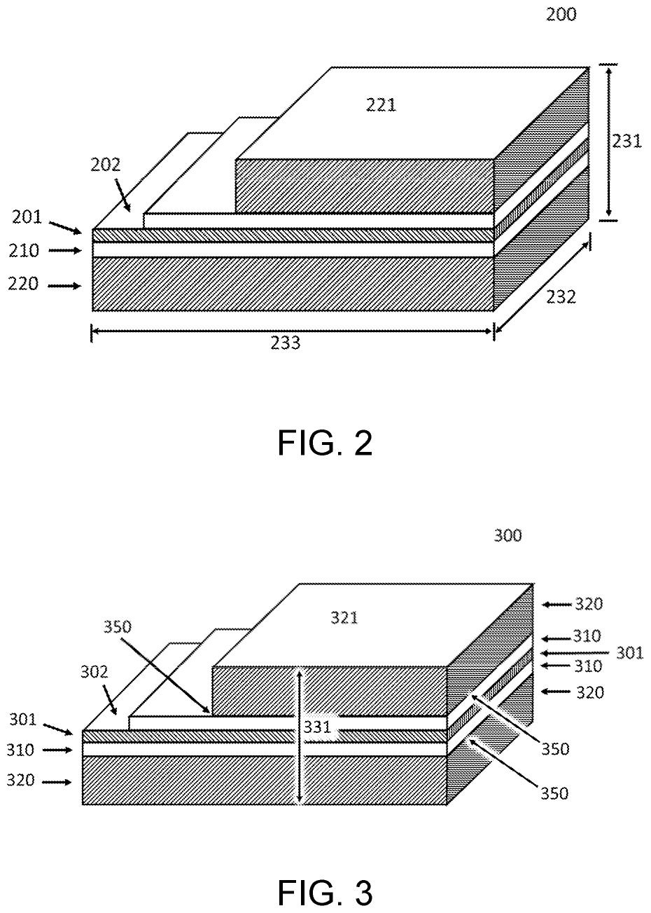

Herewith, a first embodiment is a lithium metal anode 100 for use in a battery with a layered structure depicted in FIG. 1. The anode 100 can include a current collector 101 having a first face 102 and a second face 102, each face, individually, carrying a proximal lithium metal layer 110 that carries a distal lithium metal layer 120. That is the current collector 101, preferably a thin foil or sheet, has a first and a second side, where each side carries first a proximal lithium metal layer 110 (nearer the foil or sheet surface) and then a distal lithium metal layer 120, where the proximal lithium metal layer 110 is sandwiched between the current collector 101 and the distal lithium metal layer 120. Preferably, the distal lithium metal layer 120 is not in direct physical contact with the current collector 101 and is separated from the current collector 101 by, at least, the proximal lithium metal layer 110.

The proximal lithium metal layer 110, preferably, includes greater than about 98 wt. %, 99 wt. %, 99.5 wt. %, or 99.9 wt. % lithium. More preferably, the proximal lithium metal layer 110 consists essentially of, or consists of lithium. Typically, the proximal lithium metal layer 110 has a proximal thickness 111 of about 100 nm to about 25 μm, about 250 nm to about 20 μm, about 250 nm to about 15 μm, about 250 nm to about 10 μm, about 250 nm to about 5 μm, or about 500 nm to about 5 μm. In one instance, the thickness 111 of the proximal lithium metal layer 110 is only limited by the requirement for the presence of lithium having a concentration of greater than 99 wt. %, 99.5 wt. %, or 99.9 wt. %, for example in a core of the layer. In another instance, the proximal lithium metal layer 110 can have a proximal thickness of less than about 100 nm, 75 nm, 50 nm, 25 nm, 20 nm, 15 nm, 10 nm, 5 nm, or 2.5 nm. In this instance, the composition of the proximal lithium metal layer 110 may include elements or alloys that are admixtures of the current collector 101 composition and the lithium metal. In one instance, the proximal lithium metal layer 110 includes copper when the proximal lithium metal layer is carried on a copper current collector. Preferably, this instance includes a proximal lithium metal surface 113 that includes greater than about 60 wt. %, 70 wt. %, 80 wt. %, 90 wt. %, 95 wt. %, 98 wt. %, or 99 wt. % lithium.

In still another instance, the proximal lithium metal layer 110 can have a proximal average grain 112 size of about 50 nm to about 5 μm, about 50 nm to about 2.5 μm, or about 50 nm to about 1 Herewith, the proximal average grain 112 size is preferably the proximal lithium metal surface grain size and is determined by microscopic investigation of a proximal lithium metal layer prior to preparation or addition of the distal lithium metal layer. Alternatively, the proximal average grain size can be determined by cross-sectional microscopic investigation, for example by FIB-SEM of the proximal lithium metal layer prior to or after preparation or addition of the distal lithium metal layer.

The distal lithium metal layer 120, preferably, includes greater than about 90 wt. %, 95 wt. %, about 98 wt. %, 99 wt. %, 99.5 wt. %, or 99.9 wt. % lithium. More preferably, the distal lithium metal layer 120 consists essentially of, or consists of lithium. Typically, the distal lithium metal layer 120 has a distal thickness 121 of about 10 μm to about 200 μm, about 25 μm to about 175 μm, about 50 μm to about 150 μm, about 50 μm to about 125 μm, about 50 μm to about 100 μm. In addition to being thicker than the proximal lithium metal layer 110, the distal lithium metal layer 120, preferably, has a larger grain 122 size. Accordingly, the distal lithium metal layer 120 can have a distal average grain 122 size of about 0.1 μm to about 1000 μm, about 0.1 μm to about 500 μm, about 0.1 μm to about 250 μm, about 0.1 μm to about 200 μm, about 0.1 μm to about 150 μm, about 0.1 μm to about 100 μm, about 0.1 μm to about 75 μm, about 0.1 μm to about 50 μm, about 0.1 μm to about 25 μm, about 0.1 μm to about 20 μm, about 2 μm to about 20 μm, about 2 μm to about 15 μm, about 0.1 μm to about 20 μm, about 0.25 μm to about 20 μm, about 0.5 μm to about 20 μm, or about 0.75 μm to about 20 More preferably, the distal lithium metal layer has a distal average grain 122 size that is at least 1.5, 2, 2.5, 3, 3.5, 4, 4.5, 5, 7.5, 10, 15, 20, 25, 30, 35, 40, 45, 50, 75, 100 times the size of the proximal average grain 112 size.

The lithium metal anode 100 can further include a distal lithium surface 123 that is parallel to the current collector face 102. Preferably, the distal lithium surface 123 is an external surface of the lithium metal anode 100. In a preferred instance, the distal lithium surface 123 is parallel with the current collector face 102. More preferably, lithium metal anode has a center-to-edge thickness variation between the distal lithium surface and a current collector face that is less than 5 μm, 4 μm, 3 μm, 2 μm, or 1 μm. That is, the layer structures that provide the lithium metal anode may be thicker in the center of the anode than along an edge and accordingly, this thickness variation is as small as possible and is preferably zero. Herewith, the center-to-edge thickness variation is a measure of the thickness variation on one side of the lithium metal anode. Depending on the method of measurement, the total thickness of the lithium metal anode can be measured (e.g., from one distal lithium surface to the opposing distal lithium surface) and in this instance, the center-to-edge thickness variation for the anode is preferably less than about 10 μm, 7 μm, 5 μm, 4 μm, 3 μm, 2 μm, or 1 μm. In a preferable example, the total thickness is about 50 μm to 500 μm, about 50 μm to about 300 μm, about 50 μm to about 250 μm, about 50 μm to about 200 μm, about 50 μm to about 175 μm, or about 50 μm to about 150 μm.

In one instance of the lithium metal anode 100, the current collector 101 can be a copper foil, preferably, having a thickness 103 of about 4 μm to about 15 μm, about 5 μm to about 12 μm, or about 6 μm to about 10 μm. In another instance, the current collector can be a nickel foil. In still another instance, the current collector can be a polymer that, preferably, includes wires or coatings of a low resistivity metal (e.g., copper).

A particularly preferable lithium metal anode has a proximal composition and a distal composition that are both high purity in lithium. For example, the proximal and distal composition can both include greater than about 99 wt. %, 99.5 wt. %, or 99.9 wt. % lithium.

A second embodiment is a lithium foil 200 that includes a core metal foil 201 and on a first side a first planar face 202 carrying first, a first proximal lithium metal layer 210 and then a first distal lithium metal layer 220, and on a second side a second planar face 202 carrying first, a second proximal lithium metal layer 210 and then a second distal lithium metal layer 220. Accordingly, the lithium foil is preferably center symmetric with the same layers extending out from a midpoint or middle layer.

In one instance, the core metal foil 201 can have a width 232 of about 10 cm to about 100 cm, or about 20 cm to about 750 cm, or about 20 cm to about 600 cm, and a length 233 of greater than about 10 m, 20 m, 25 m, 50 m, 75 m, or 100 m. In a preferable instance, the core metal foil 201 is a coil or length of foil that exceeds 200 m, 300 m, 400 m, or 500 m. Notably, the length 233 of the core metal foil 201 is greater than its width 232 and preferably greater by at least a factor of 2, 5, 10, 15, 20, 25, or more. Preferably, the core metal foil 201 consists essentially of or consists of copper.

The core metal foil 201 has a first planar face and a second planar face (202, individually) and therebetween a thickness (represented in the direction indicated by 231) that is, preferably, about 4 μm to about 15 μm, about 5 μm to about 12 μm, or about 6 μm to about 10 μm. Furthermore, the first planar face 202 carries the first proximal lithium metal layer 210 that carries the first distal lithium metal layer 220, and the second planar face 202 carries the second proximal lithium metal layer 210 that carries the second distal lithium metal layer 220.

Each proximal lithium metal layer 210 (the first and the second), individually, can have a proximal thickness (represented in the direction indicated by 231) of about 5 nm to about 25 μm, 25 nm to about 25 μm, 100 nm to about 25 μm, about 250 nm to about 20 μm, about 250 nm to about 15 μm, about 250 nm to about 10 μm, about 250 nm to about 5 μm, or about 500 nm to about 5 μm, can have an proximal average grain size of about 50 nm to about 5 μm, about 50 nm to about 2.5 μm, or about 50 nm to about 1 μm; and can have a proximal composition that includes greater than about 98 wt. %, 99 wt. %, 99.5 wt. %, or 99.9 wt. % lithium. Similarly, each distal lithium metal layer 220, individually, can have a distal thickness (represented in the direction indicated by 231) of about 10 μm to about 200 μm, about 25 μm to about 175 μm, about 50 μm to about 150 μm, about 50 μm to about 125 μm, about 50 μm to about 100 μm; can have an distal average grain size of about 0.1 μm to about 20 μm, about 0.25 μm to about 20 μm, about 0.5 μm to about 20 μm, about 0.75 μm to about 20 μm, about 1 μm to about 20 μm, 1 μm to about 2000 μm, 1 μm to about 1500 μm, 1 μm to about 1000 μm, 1 μm to about 750 μm, 1 μm to about 500 μm, 1 μm to about 250 μm, 1 μm to about 150 μm, 1 μm to about 100 μm, 1 μm to about 75 μm, 1 μm to about 50 μm, 1 μm to about 20 μm, about 2 μm to about 20 μm, or about 2 μm to about 15 Each distal lithium metal layer can further have, individually, a distal average grain size that is at least 1.5, 2, 2.5, 3, 3.5, 4, 4.5, 5 times the size of the proximal average grain size. Still further, each distal lithium metal layer can have a distal composition that includes greater than about 90 wt. %, 95 wt. %, or 98 wt. % lithium and these distal lithium metal layers, preferably, have, individually, distal lithium surfaces that are parallel to the first and second planar face, respectively. For example, the first distal lithium metal layer preferably has a first distal lithium surface that is parallel to the first planar face.

As the lithium foil include first and second distal lithium surfaces 221, the lithium foil further includes a thickness between these surfaces 231. While the surfaces are preferably parallel, there may be a thickness variation between a center and an edge of the lithium foil (notably across the width of the foil whereas along the length of the foil the thickness is consistent relative to the position across the width). Preferably, the width-thickness variation is less than 5 μm, 4 μm, 3 μm, 2 μm, or 1 μm. More preferably, the center-to-edge thickness variation for the lithium foil is preferably less than about 10 μm, 7 μm, 5 μm, 4 μm, 3 μm, 2 μm, or 1 μm. In a preferable example, the total thickness (first to second distal surfaces) is about 50 μm to 500 μm, about 50 μm to about 300 μm, about 50 μm to about 250 μm, about 50 μm to about 200 μm, about 50 μm to about 175 μm, or about 50 μm to about 150 μm.

FIG. 3 depicts a third embodiment that features a double-sided lithium weldment 300 having a thickness 331 of about 50 μm to 500 μm, about 50 μm to about 300 μm, about 50 μm to about 250 μm, about 50 μm to about 200 μm, about 50 μm to about 175 μm, or about 50 μm to about 150 μm. The lithium weldment 300, preferably, includes a current collector 301 metallurgically affixed on a first face 302 to a first lithium layer 310 and on a second face 302 to a second lithium layer 310. Thereafter working from the current collector 301 outwardly from a core or middle location toward either face 302 then from either lithium layer 310, there is a weld interface 350 and thereafter a lithium foil 320. Accordingly, on the first side, there is the first face then the first lithium layer and a first weld interface between the first lithium layer and a first lithium foil, and on the second side, there is the second face then the second lithium layer and a second weld interface between the second lithium layer and a second lithium foil. The weld interfaces 350, preferably and individually, have a thickness of less than 250 nm, 200 nm, 150 nm, 100 nm, 75 nm, or 50 nm but greater than about 0.5 nm, 1 nm, or 2.5 nm.

Notably and due in part to the high reactivity of lithium surfaces, the faces of the lithium layer and the lithium foil are typically unable to be cleaned of all surface contamination prior to the preparation of the weldment. Accordingly, the weld interface 350 typically includes a plurality of particulates or particles that can be the result of a reaction of a lithium surface with nitrogen, oxygen, or water. In one example, the weld interface includes lithium oxide, a lithium nitride, lithium hydroxide, lithium carbonate, or an admixture thereof.

An interesting feature of the lithium layers and the lithium foils is the grain sizes observable in the lithium metal (e.g., the grain sizes can be visualized through selective etching and imaging of the lithium in either or both of the cross-sections and the faces). In a preferable instance, the lithium layer has a grain size that is significantly smaller than the grain size of the lithium foil. In a particular instance, the double-sided lithium weldment has a first lithium layer that has a first lithium-layer grain size and a second lithium layer that has a second lithium-layer grain size. The weldment further has a first lithium foil that has a first lithium-foil grain size; and a second lithium foil that has a second lithium-foil grain size. In one example, the first lithium-foil grain size is at least 1.5, 2, 2.5, 3, 3.5, 4, 4.5, 5 times the first lithium-layer grain size. In another non-exclusive example, the second lithium-foil grain size is at least 1.5, 2, 2.5, 3, 3.5, 4, 4.5, 5 times the second lithium-layer grain size. In another particularly preferable instance, the grain direction of the lithium layers and the lithium foils are distinct and in one example, the grain direction of the lithium layer is perpendicular to the grain direction of the lithium foil. In yet another example, the grain direction of the lithium foils is longitudinal (extending along the length of the foil) as opposed to axial (extending across the thickness of the foil), whereas the grain direction of the lithium layer(s) is axial (e.g., extending from the current collector toward the lithium foil).

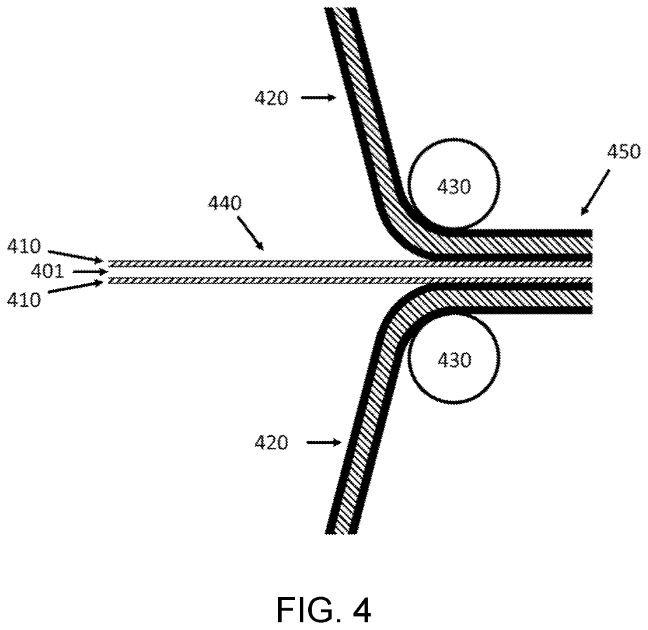

FIG. 4 depicts aspects of yet another embodiment which is a process that can be used for the preparation of the above-described weldments. In one instance, the process includes welding a lithium foil 420 to a lithium anode 440 that includes a current collector 401 carrying a metallurgically adhered lithium layer 410 thereby forming a lithium weldment 450. The process of welding can include solid-state welding, cold welding, pressure welding, or can include calendaring (for example by rolling the layers through calendar rollers 430) the lithium foil 420 and the lithium anode 440 thereby providing a weld interface therebetween. In a preferable example, the lithium foil 420 is welded to the metallurgically adhered lithium layer 410. In another preferable example, the lithium foils have thicknesses, the lithium anode has a thickness, and a sum of a lithium foil thickness and lithium anode thickness is greater than a lithium weldment thickness. In the process, the sum of a lithium foil thickness and a lithium anode thickness is about 1 μm, about 2 μm, about 3 μm, about 4 μm, or about 5 μm greater than the lithium weldment thickness. That is, the sum of the thicknesses prior to the formation of the weldment are greater than the thickness of the final weldment by about 10 μm, 9 μm, 8 μm, 7 μm, 6 μm, 5 μm, 4 μm, 3 μm, 2 μm, or 1 μm. Notably, the smaller thickness of the weldment may be provided by rolling or calendaring the foils and anode.

Still yet another embodiment is a process of forming a double-sided lithium weldment, where the first side and the second side of the weldment are contemporaneously formed, e.g., as depicted in FIG. 4. The process can include providing a first lithium foil 420 and a second lithium foil 420, e.g., by cold rolling lithium ingots or lithium bar, and providing a double-sided lithium anode 440 that has a first lithium layer 410 metallurgically affixed to a first surface of a current collector 401 and a second lithium layer 410 metallurgically affixed to a second surface of the current collector 401. The double-sided lithium anode 440 can be provided by, for example, a vapor depositing a copper current collector with lithium. Thereafter, the process can include positioning the double-sided lithium anode 440 between the first lithium foil 420 and the second lithium foil 420 such that the first lithium foil 420 is adjacent to the first lithium layer 410 and the second lithium foil 420 is adjacent to the second lithium layer 410. Once this stacked structure is prepared, the process includes contemporaneously welding the first lithium foil to the first lithium layer and the second lithium foil to the second lithium layer thereby forming the double-sided lithium weldment 450.

The double-sided lithium anode can be commercially obtained or, preferably, can be provided by vapor deposition, or physical vapor deposition (PVD) of lithium onto a current collector. Notably, the PVD process is typically conducted in vacuo, preferably at a sufficient pressure to allow for the evaporation of lithium at temperatures below about 600° C., 500° C., or 400° C. Even more preferably, the process includes positioning the double-sided lithium anode between the first and second lithium foils without exposing the double-sided lithium anode to oxygen or nitrogen. In one instance, the positioning process occurs in vacuo, in another instance, the positioning process occurs in an argon environment. In other instances, the positioning may occur in a dry room where the lithium (anode and foils) is exposed to dry air, preferably having a dew point of less than about −50° C., −60° C., −70° C., or −80° C.

The welding of the lithium foils to the double-sided lithium anode is preferably accomplished or performed at a temperature of or below about 100° C., 90° C., 80° C., 70° C., 60° C., 50° C., 40° C., 30° C., 20° C., 10° C., or 0° C.; preferably at or below about 50° C., 40° C., 30° C., or 20° C. While the welding can be accomplished in a dry atmosphere, preferably an atmosphere free of nitrogen and oxygen, even more preferably under argon; the welding is still more preferably performed in vacuo.

The welding of the materials, preferably, forms a first weld interface between the first lithium foil and the first lithium layer, and forms a second weld interface between the second lithium foil and the second lithium layer. In one instance, the welding includes solid-state welding, in another instance, the welding includes cold welding, in still another instance, the welding includes pressure welding. In a particularly preferably instance, the welding includes calendaring the double-sided lithium anode between the first lithium foil and the second lithium foil.

The foils individually have thicknesses, i.e., the first lithium foil has a first foil thickness and the second lithium foil has a second foil thickness, that are between about 10 μm to about 200 μm, about 25 μm to about 175 μm, about 50 μm to about 150 μm, about 50 μm to about 125 μm, about 50 μm to about 100 Preferably, the foils have the same or approximately the same thickness. For example, the first foil thickness is approximately equal to the second foil thickness. In another example, the first foil thickness can be about 1 μm, about 2 μm, about 3 μm, about 4 μm, about 5 μm, about 7.5 μm, or about 10 μm greater than the second foil thickness. In a preferable example, the first foil and the second foil are cut from a single larger foil and accordingly have the same thickness.

Notably, the anode has a first lithium layer that has a first anode-layer thickness and a second lithium layer that has a second anode-layer thickness. Preferably, the first and the second anode-layer thicknesses are, individually, about 100 nm to about 20 μm, about 250 nm to about 20 μm, about 250 nm to about 20 μm. In one instance, the first and the second anode-layer thicknesses are about 100 nm to about 5 μm, about 100 nm to about 2 μm, about 100 nm to about 1 μm, or about 100 nm to about 500 nm. In another instance, the first and the second anode-layer thicknesses are about 1 μm to about 20 μm, about 2.5 μm to about 20 μm, about 5 μm to about 20 μm, or about 7.5 μm to about 20 μm. In a preferable instance, the first anode-layer thickness is approximately equal to the second anode-layer thickness, more preferably within about 1 μm, 750 nm, 500 nm, 250 nm, 150 nm, 100 nm, or 50 nm of the second anode-layer thickness.

In a particularly preferable example, the first lithium foil has a first foil thickness between about 10 μm to about 200 μm, about 25 μm to about 175 μm, about 50 μm to about 150 μm, about 50 μm to about 125 μm, about 50 μm to about 100 μm, the second lithium foil has a second foil thickness between about 10 μm to about 200 μm, about 25 μm to about 175 μm, about 50 μm to about 150 μm, about 50 μm to about 125 μm, about 50 μm to about 100 μm; the first lithium layer has a first anode-layer thickness between about 100 nm to about 20 μm, about 250 nm to about 20 μm, about 250 nm to about 20 μm; the second lithium layer has a second anode-layer thickness between about 100 nm to about 20 μm, about 250 nm to about 20 μm, about 250 nm to about 20 μm; the current collector has a current collector thickness between about 4 μm to about 15 μm, about 5 μm to about 12 μm, or about 6 μm to about 10 μm; and the double layer weldment has a thickness that is less than a sum of the first foil thickness, the second foil thickness, the first anode-layer thickness, the second anode-layer thickness, and the current collector thickness. In accordance with the description above, double layer weldment thickness is, preferably, about 500 nm to about 10 μm, about 1 μm to about 7.5 μm, about 1 μm to about 5 μm, or about 1 μm to about 2.5 μm less than the sum of thicknesses.

Yet another embodiment is a process of forming a double-sided lithium weldment, where the first side and the second side of the weldment are contemporaneously formed from a double-sided lithium anode and a single sheet of a lithium foil. In this embodiment, the lithium foil can be folded about the double-sided lithium anode thereby providing a double-sided weldment with a continuous lithium surface from a first external surface to a second external surface.

While the compositions and methods of this invention have been described in terms of preferred embodiments, it will be apparent to those of skill in the art that variations may be applied to the compositions and/or methods in the steps or in the sequence of steps of the method described herein without departing from the concept, spirit and scope of the invention. More specifically, it will be apparent that certain agents that are both chemically and physically related may be substituted for the agents described herein while the same or similar results would be achieved. All such similar substitutes and modifications apparent to those skilled in the art are deemed to be within the spirit, scope and concept of the invention as defined by the appended claims.

We claim:

1. (canceled)

2. (canceled)

3. (canceled)

4. (canceled)

5. (canceled)

6. (canceled)

7. (canceled)

8. (canceled)

9. A process comprising:
welding a lithium foil to a lithium anode that includes a current collector carrying a metallurgically adhered lithium layer thereby forming a lithium weldment.

10. (canceled)

11. (canceled)

12. (canceled)

13. The process of claim 8, wherein the welding includes calendaring the lithium foil and the lithium anode thereby providing a weld interface therebetween.

14. (canceled)

15. The process of claim 8, wherein a sum of a lithium foil thickness and lithium anode thickness is greater than a lithium weldment thickness.

16. (canceled)

17. A process of forming a double-sided lithium weldment, comprising:
providing a first lithium foil and a second lithium foil;
providing a double-sided lithium anode that has a first lithium layer metallurgically affixed to a first surface of a current collector and a second lithium layer metallurgically affixed to a second surface of the current collector;
positioning the double-sided lithium anode between the first lithium foil and the second lithium foil such that the first lithium foil is adjacent to the first lithium layer and the second lithium foil is adjacent to the second lithium layer; and then
contemporaneously welding the first lithium foil to the first lithium layer and the second lithium foil to the second lithium layer thereby forming the double-sided lithium weldment, wherein the double-sided lithium weldment defines a respective lithium metal-lithium metal weld interface between each of:
the first lithium foil and the first lithium layer, and
the second lithium foil and the second lithium layer.

18. The process of claim 17, wherein providing the double-sided lithium anode includes physical vapor depositing lithium onto the current collector in vacuo.

19. (canceled)

20. (canceled)

21. (canceled)

22. The process of claim 17, wherein the welding is at or below about 100° C.

23. (canceled)

24. The process of claim 17, wherein welding forms a first weld interface between the first lithium foil and the first lithium layer; and forms a second weld interface between the second lithium foil and the second lithium layer.

25. (canceled)

26. (canceled)

27. (canceled)

28. (canceled)

29. (canceled)

30. (canceled)

31. (canceled)

32. The process of claim 17, wherein the first lithium layer has a first anode-layer thickness; wherein the second lithium layer has a second anode-layer thickness; and wherein the first and the second anode-layer thicknesses are, individually, about 100 nm to about 20 μm.

33. (canceled)

34. The process of claim 17,
wherein the first lithium foil has a first foil thickness between about 10 μm to about 200 μm;
wherein the second lithium foil has a second foil thickness between about 10 μm to about 200 μm;
wherein the first lithium layer has a first anode-layer thickness between about 100 nm to about 20 μm;
wherein the second lithium layer has a second anode-layer thickness between about 100 nm to about 20 μm;
wherein the current collector has a current collector thickness between about 4 μm to about 15 μm; and
wherein the double layer weldment has a thickness that is less than a sum of the first foil thickness, the second foil thickness, the first anode-layer thickness, the second anode-layer thickness, and the current collector thickness.

35. (canceled)

36. The process of claim 17, wherein said contemporaneously welding comprises calendaring the double-sided lithium anode between the first lithium foil and the second lithium foil using opposing calendar rollers, each calendar roller of the opposing calendar rollers contemporaneously forming a respective lithium weldment of the double-sided lithium weldment.
